(19) United States
(12) Patent Application Publication
(10) Pub. No.: US 2024/0413463 A1
(43) Pub. Date: Dec. 12, 2024

(54) BATTERY PACK ASSEMBLY

(71) Applicant: Rivian IP Holdings, LLC, Irvine, CA (US)

(72) Inventors: Sharbel elKantati, Leamington (CA); Adam Richard Ballard, Corona, CA (US)

(21) Appl. No.: 18/333,111

(22) Filed: Jun. 12, 2023

(51) Int. Cl. H01M 50/249; H01M 50/24; H01M 50/291

(52) U.S. Cl. CPC H01M 50/249; H01M 50/24; H01M 50/291

(57) ABSTRACT

An apparatus can include a plate to be disposed spaced apart from a housing. The plate configured to couple with the housing via a protrusion. A portion of the protrusion to melt to couple the plate with the housing.

### INTRODUCTION

Battery packs can be a source of electric power for electric vehicles.

### SUMMARY

At least one aspect is directed to an apparatus. The apparatus can include a plate. The plate can be disposed apart from a housing. The plate can be configured to couple with the housing via a protrusion, the protrusion can have a first melting point. At least one of the housing or the plate can have a second melting point, the first melting point can be different than the second melting point

At least one aspect is directed to an apparatus. The apparatus can include a housing. The apparatus can include a plate to space from the housing. The apparatus can include a protrusion to dispose between the housing and the plate. The plate can couple with the housing via the protrusion. The protrusion can have a first melting point and at least one of the housing or the plate can have a second melting point. The first melting point can be lower than the second melting point.

At least one aspect is directed to a method. The method can include disposing a plate away from a housing. The method can include coupling the plate with the housing via a protrusion. A portion of the protrusion can melt to couple the housing with the plate.

At least one aspect is directed to a method. The method can include providing a housing. The method can include disposing a plate away from the housing. The method can include disposing a protrusion between the housing and the plate. A portion of the protrusion can melt to couple the housing with the plate. The method can include coupling the housing with the plate via the protrusion.

At least one aspect is directed to an electric vehicle. The electric vehicle can include a battery pack comprising a housing. The electric vehicle can include a plate disposed away from the housing and external to the electric vehicle. The electric vehicle can include a protrusion disposed between the housing and the plate. The plate can couple with the housing via the protrusion. The protrusion can have a first melting point and at least one of the housing or the plate can have a second melting point. The first melting point can be less than the second melting point.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a cross-sectional view of an example battery pack assembly, in accordance with some aspects.

FIG. 2 depicts a cross-sectional view of an example battery pack assembly, in accordance with some aspects.

FIG. 3 depicts cross-sectional views of example battery pack assemblies, in accordance with some aspects.

FIG. 4 depicts a cross-sectional view of an example protrusion, in accordance with some aspects.

FIG. 5 depicts a cross-sectional view of an example protrusion, in accordance with some aspects.

FIG. 6 depicts a cross-sectional view of an example protrusion, in accordance with some aspects.

FIG. 7 depicts a cross-sectional view of an example protrusion, in accordance with some aspects.

FIG. 8 is a top view of example protrusions, in accordance with some aspects.

FIG. 9 depicts a perspective view of a protrusion grid, in accordance with some aspects.

FIG. 10 depicts a perspective cross-sectional view of an example battery pack assembly, in accordance with some aspects.

FIG. 11 depicts a cross-sectional view of an electric vehicle, in accordance with some aspects.

FIG. 12 depicts a flow diagram illustrating an example method of providing a battery pack assembly, in accordance with some aspects.

### DETAILED DESCRIPTION

Following below are more detailed descriptions of various concepts related to, and implementations of, methods, apparatuses, and systems of a battery pack assembly. The various concepts introduced above and discussed in greater detail below may be implemented in any of numerous ways.

The present disclosure is directed to systems and methods for providing a battery pack assembly. For example, the present disclosure is directed to a battery pack assembly that can include a plate to protect a battery pack, and the contents disposed therein. Protrusions can be disposed between the plate and the battery pack. The protrusions can couple a housing of the battery pack with the plate, or vice versa, by being melted, at least partially, onto at least one of the plate or the housing of the battery pack. No mechanical fasteners (e.g., screws, bolts, nails, etc.) are needed for the protrusions to couple with the plate or the housing. For example, the protrusions can be integral with one of the housing or the plate. For example, the protrusions and the housing can form a single structure or the protrusions and the plate can form a single structure. The protrusions can have a first melting point. The other of the housing or the plate with which the protrusions are not integral can have a second melting point. The first melting point can be lower than the second melting point. Heat can be applied to the other of the housing or the plate to a temperature greater than the first melting point or between the first and second melting point to melt a tip of the protrusion as the tip contacts the other of the plate of the housing.

The disclosed solutions use few or no mechanical fasteners to couple a plate with a housing of a battery pack to provide protection to the battery pack. A component of the battery pack assembly can be melted to create a single assembly. Melting the components together can reduce or eliminate holes and cavities used to accommodate mechanical fasteners, which traditionally can lead to leakage paths for contaminants to enter the assembly and damage internal components of the assembly. The disclosed solutions can provide a light weight, strong, and cost-effective solution to also protect an exterior of the battery pack.

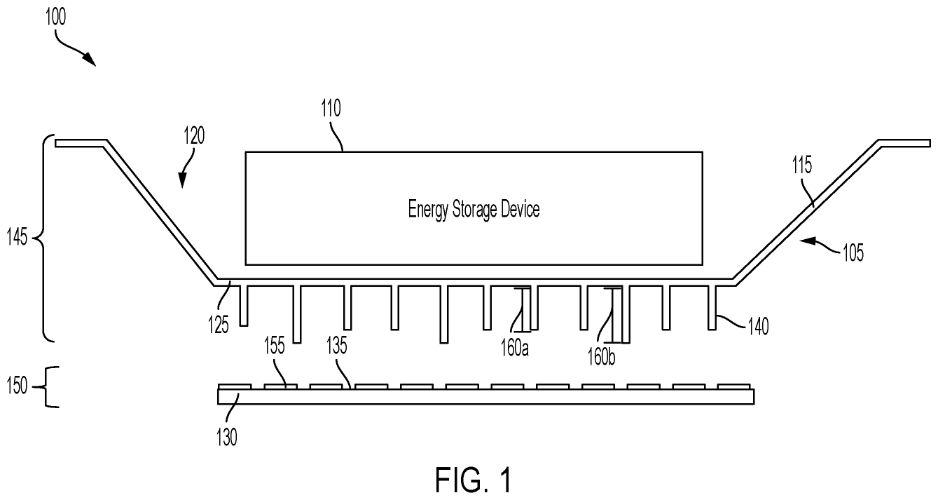

FIG. 1 depicts a cross-sectional view of an example battery pack assembly 100. The battery pack assembly 100 can house and protect for a battery pack 105. For example, the battery pack assembly 100 can prevent substances from entering or contacting the battery pack 105. The battery pack assembly 100 can mitigate forces exerted on the battery pack 105 when an object (e.g., an electric vehicle) containing the battery pack 105 is moving. The battery pack 105 can be or include at least one energy storage device 110. The energy storage device 110 can be or include at least one battery, battery module, or battery cell, among others.

The battery pack assembly 100 can include a housing 115. The housing 115 can at least partially enclose the battery pack 105. For example, the housing 115 can define at least one cavity 120. The cavity 120 can receive the battery pack 105.

The housing 115 can include at least one housing coupling surface 125. The housing coupling surface 125 can be an external surface of the housing 115. The housing coupling surface 125 can face away from the cavity 120. The housing coupling surface 125 can couple with other components of the battery pack assembly 100. The housing coupling surface 125 can have any shape. For example, the housing coupling surface 125 can be flat, wavy, asymmetrical, etc.

The battery pack assembly 100 can include at least one plate 130. The plate 130 can be spaced from the housing 115 by the at least one protrusion 140. The plate 130 can be disposed opposite the housing coupling surface 125. The plate 130 can couple with the housing 115 using the at least one protrusion 140. For example, the plate 130 can include at least one plate coupling surface 135. The plate 130 can couple with the housing 115 via the plate coupling surface 135 and the housing coupling surface 125. The plate coupling surface 135 can have a shape that conforms to the shape of the housing coupling surface 125. For example, the plate coupling surface 135 can have a shape that is flat, wavy, asymmetrical, etc. that mirrors or corresponds to the shape of the housing coupling surface 125. At least a portion of the shape of the plate coupling surface 135 can be different than at least a portion of the shape of the housing coupling surface 125. For example, at least a portion of the housing coupling surface 125 can be wavy or have ribs, and a corresponding portion of the plate coupling surface 135 that faces the portion of the housing coupling surface 125 can be flat, or vice versa.

The battery pack assembly 100 can include at least one protrusion 140. The protrusion 140 can be disposed between the housing 115 and the plate 130. For example, the protrusion 140 can be disposed between the housing coupling surface 125 and the plate coupling surface 135. The housing 115 can couple with the plate 130 via the protrusion 140. For example, the protrusion 140 can extend between the housing 115 and the plate 130. At least a portion of the protrusion 140 can be configured to melt to couple the plate 130 with the housing 115.

The battery pack assembly 100 can include at least one protrusion component 145 and at least one heating component 150. The protrusion component 145 can be a component (e.g., housing 115 or plate 130) of the battery pack assembly 100 that includes or is integral with the protrusion 140. For example, the protrusion component 145 can include the protrusion 140 and one of the housing 115 or the plate 130. For example, the protrusion component 145 can include the protrusion 140 and the housing 115. The protrusion 140 can be integral with the housing 115. For example, the protrusion 140 and the housing 115 can form a single, monolithic structure (e.g., the protrusion 140 can be formed integrally with the housing 115). The protrusion component 145 can include the protrusion 140 and the plate 130. The protrusion 140 can be integral with the plate 130. For example, the protrusion 140 and the plate 130 can form a single, monolithic structure (e.g., the protrusion 140 can be formed integrally with the plate 130). The heating component 150 can be the other of the housing 115 or plate 130 that is not integral with the protrusion 140. The heating component 150 can receive energy to increase a temperature of the heating component 150 to facilitate coupling of the protrusion component 145 with the heating component 150. For example, the protrusion component 145 can be made of a first material. The first material can be, for example, a metal, a polymer (e.g., plastic), or a composite, among other materials. The first material can include a filler. For example, the filler can be a carbon fiber or a glass fiber. The amount of filler throughout the protrusion component 145 can vary. The first material can have a first melting point. The heating component 150 can be made of a second material. The second material can be, for example, a metal, a polymer (e.g., plastic), or a composite, among other materials. The second material can include a filler. For example, the filler can be carbon fiber or glass fiber. The second material can have a second melting point. The first melting point can be lower than the second melting point. The heating component 150 can receive energy to increase the temperature of the heating component 150 to a temperature at or above the first melting point and below the second melting point. The heated heating component 150 can contact the protrusion 140 of the protrusion component 145 to melt at least a portion of the protrusion 140 to couple the heating component 150 with the protrusion component 145.

The heating component 150 can include a bonding agent 155. The bonding agent 155 can be any agent that can couple a protrusion 140 with a housing 115 or a plate 130. For example, the bonding agent can be a hot melt or an adhesive (e.g., epoxy, polyurethane, cyanoacrylate), or any other substance configured to create a physical or chemical bond between the protrusion 140 and the housing 115 or the plate 130. The bonding agent 155 can be disposed on a surface of the heating component 150. For example, the bonding agent 155 can be disposed on the housing coupling surface 125 or the plate coupling surface 135. The bonding agent 155 can be disposed between the protrusion 140 and the housing 115 or the plate 130 that is disposed away from the protrusion 140. The bonding agent 155 can be applied to the housing 115 or the plate 130 to align with the protrusion 140. The bonding agent 155 can be randomly applied to the housing 115 or the plate 130. The bonding agent 155 can be applied as a layer to a majority of the housing coupling surface 125 or the plate coupling surface 135. The bonding agent 155 can be activated by heat to facilitate coupling the housing 115 with the plate 130. The bonding agent 155 can interface with the protrusion 140 to couple the housing 115 with the plate 130 via the protrusion 140.

As depicted in FIG. 1, the protrusion component 145 can include the housing 115 and the protrusion 140. The protrusion 140 can be integral with the housing coupling surface 125. The protrusion 140 can extend away from the housing coupling surface 125. The battery pack assembly 100 can include a plurality of protrusions 140. The plurality of protrusions 140 can be integral with the housing coupling surface 125. Each protrusion 140 can have an initial length 160. The plurality of protrusions 140 can have the same or different initial lengths 160. For example, a first protrusion 140 can have a first initial length 160a and a second protrusion 140 can have a second initial length 160b. Each of the plurality of protrusions 140 can interface with the plate 130 to couple the housing 115 with the plate 130.

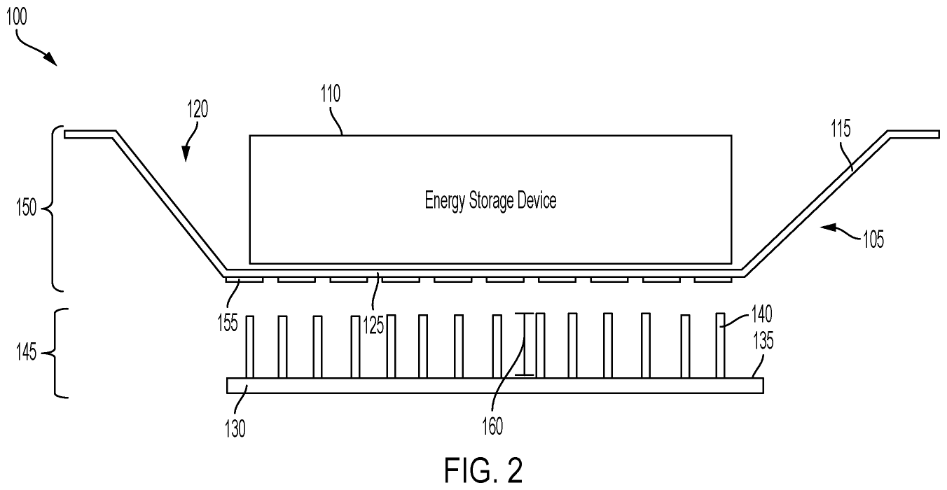

FIG. 2 depicts a cross-sectional view of an example of the battery pack assembly 100. The protrusion component 145 can include the plate 130 and the protrusion 140. The protrusion 140 can be integral with the plate coupling surface 135. The protrusion 140 can extend away from the plate coupling surface 135. The battery pack assembly 100 can include a plurality of protrusions 140. The plurality of protrusions 140 can be integral with the plate coupling surface 135. For example, the protrusions 140 and the plate coupling surface 135 can be or form a monolithic structure. The plurality of protrusions 140 can be the same or different lengths. Each of the plurality of protrusions 140 can interface with the housing 115 to couple the housing 115 with the plate 130.

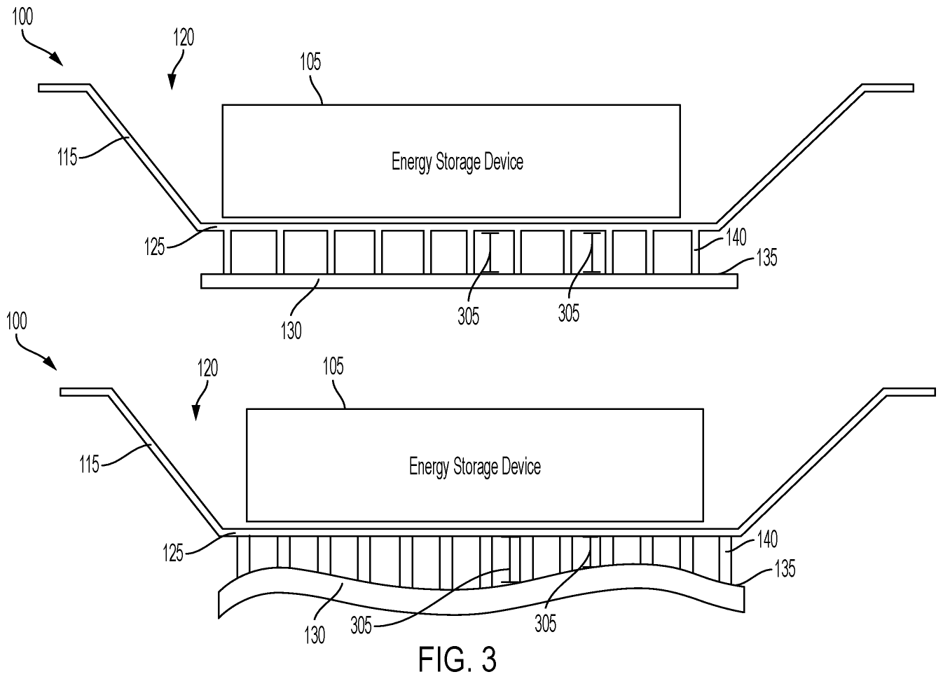

FIG. 3 depicts cross-sectional views of the battery pack assemblies 100. The battery pack assembly 100 can include a plurality of protrusions 140. Each of the plurality of protrusions 140 can extend between the housing 115 and the plate 130 with the battery pack assembly 100 assembled. Each protrusion 140 can have a coupled length 305. The coupled length 305 can be less than the initial length 160. The plurality of protrusions 140 can have the same coupled length 305 or different coupled lengths 305. For example, with a housing coupling surface 125 that has a shape that mirrors a shape of a plate coupling surface 135, a distance between the housing coupling surface 125 and the plate coupling surface 135 can remain constant such that the protrusions 140 can have the same length. With the housing coupling surface 125 comprising a shape that does not mirror a shape of the plate coupling surface 135, a distance between the housing coupling surface 125 and the plate coupling surface 135 can vary such that the protrusions 140 can have a plurality of heights to accommodate the varying distances.

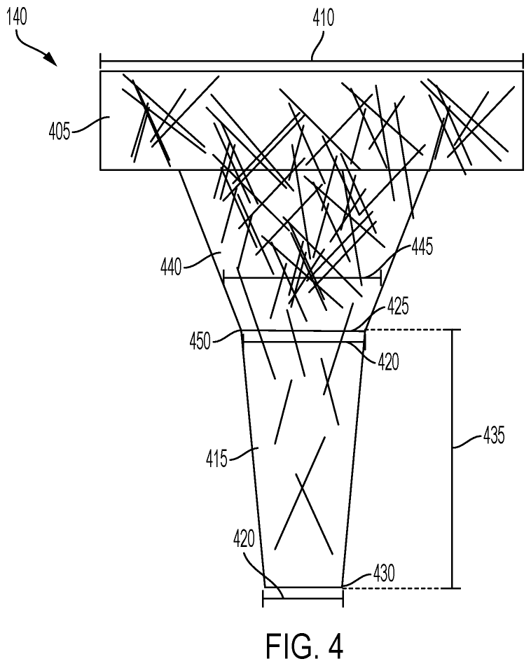

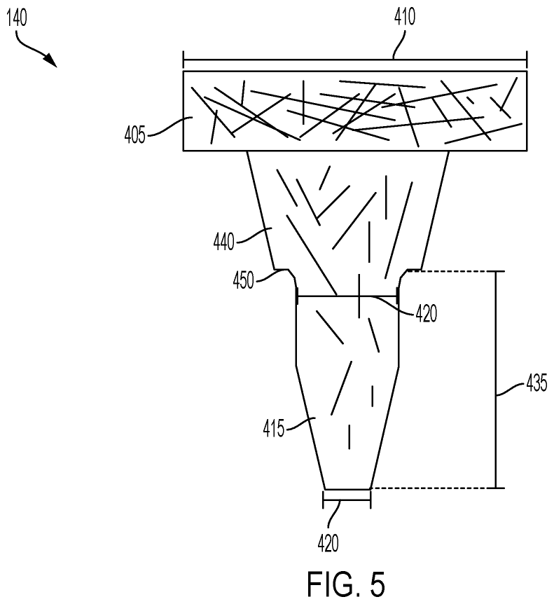

FIGS. 4-7 depict a cross-sectional views of example protrusions 140. The protrusions 140 can be any material. For example, the protrusions can be a metal, a polymer (e.g., plastic), or a composite, among other materials. The protrusion 140 can include a filler. For example, the filler can be a carbon fiber or a glass fiber. The amount of filler throughout the protrusion 140 can vary. For example, a first portion of the protrusion 140 can have a first percentage of filler and a second portion of the protrusion 140 can have a second percentage of filler. The protrusion 140 can include at least one base 405. The base 405 can be coupled with or integral with the housing 115 or the plate 130. The base 405 can have a base width 410. The base 405 can have a first percentage of a filler material. The filler material can be any filler material (e.g., carbon fibers, glass fibers, etc.). The filler material can increase strength and/or rigidity of the protrusion 140.

The protrusion 140 can include at least one tip 415. The tip 415 can be disposed away from the housing 115 or the plate 130 that the base 405 is integral or coupled with. The tip 415 can have a tip width 420. The tip width 420 can be less than the base width 410. At least a portion of the tip 415 can be tapered such that the tip width 420 varies. For example, the tip 415 can have a first tip end 425 and a second tip end 430. The tip width 420 at the first tip end 425 can be greater than the tip width 420 at the second tip end 430. The tip 415 can have a tip length 435. The tip width 420 at the first tip end 425 can be less than twice the tip length 435 with the protrusion 140 comprising the initial length 160. For example, the tip width 420 can be less than 3 mm and the tip length 435 of the protrusion 140 at an initial length 160 can be greater than 1.5 mm. The tip 415 can have a second percentage of the filler material. The second percentage can be less than the first percentage. For example, the tip 415 can be less than or equal to 20% filler material and the base 405 can be up to 60% filler material. The tip 415 can be more flexible or less rigid than the base 405 based on the smaller percentage of filler material.

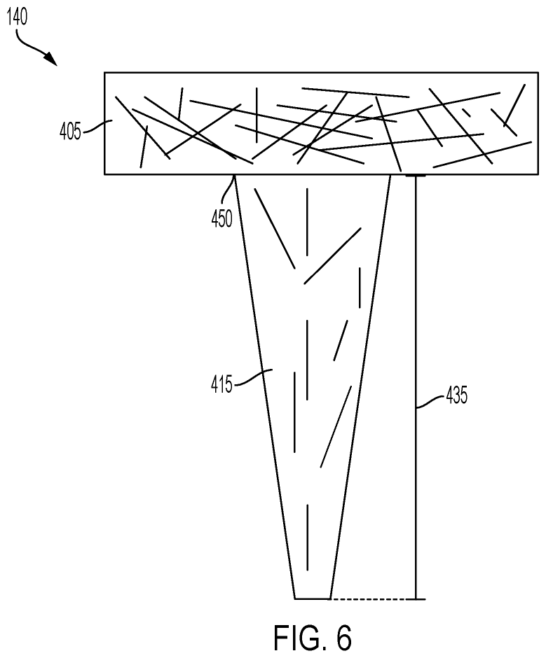

The protrusion 140 can include at least one body 440. The body 440 can be disposed between the base 405 and the tip 415. The body 440 can have a body width 445. The body 440 can be tapered such that the body width 445 varies. The body width 445 can be less than the base width 410. At least a portion of the tip 415 can have a tip width 420 that is less than the smallest body width 445. The protrusion 140 can include no body 440. For example, as depicted in FIG. 6, the tip 415 can extend directly from the base 405.

The protrusion 140 can include at least one neck 450. The neck 450 can be where the base 405 or the body 440 transitions into the tip 415. The neck 450 can limit the flow of filler material to the tip 415 to create a tip 415 that is more flexible than the base 405 and body 440. The greater flexibility can allow the tip 415 to withstand higher strain levels before cracking. The tip width 420 at the neck 450 can be based on at least one of a material of the protrusion 140, the filler material, a percentage of filler material, and or a length of the filler material. For example, the tip width 420 at the neck 450 can be less than 3 mm.

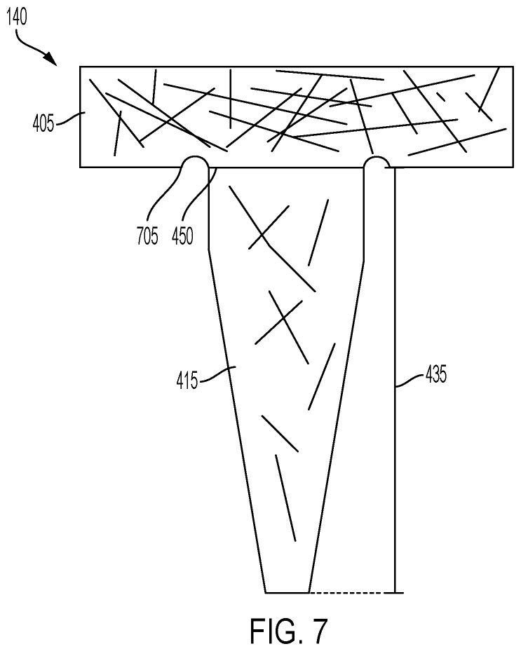

As depicted in FIG. 7, the base 405 can include at least one recess 705. The recess 705 can be disposed on one side or both sides of the tip 415 or body 440. The recess 705 can redirect flow of filler material into the tip 415 or body 440 from the base 405.

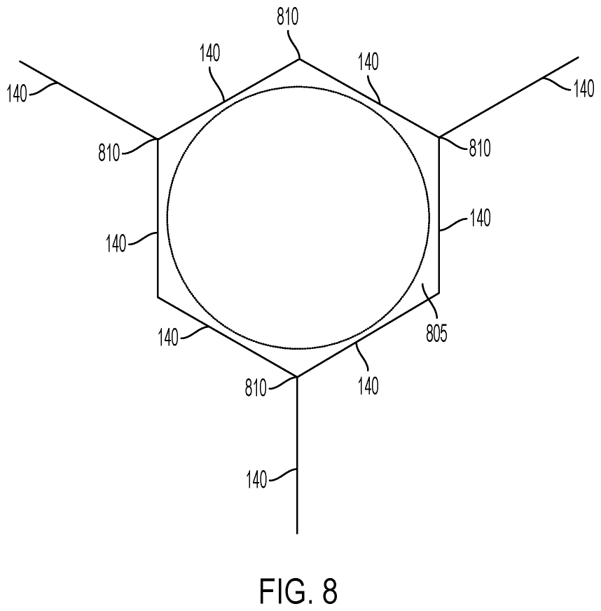

FIG. 8 depicts a top view of a plurality of protrusions 140. The protrusions 140 can be elongated structures. The protrusions 140 can be coupled together or formed together (e.g., integral with each other), or the protrusions 140 can be segmented or separated from each other. The protrusions 140 can be arranged to create at least one pocket 805. The pocket 805 can have any shape. For example, the pocket 805 can be a hexagon, square, rectangle, or triangle, among others. The pocket 805 can be any size. For example, the pocket 805 can have an area to receive an object with a diameter of at least 30 mm. The protrusions 140 can intersect or join at a joint 810 to create the pocket 805. Any number of protrusions 140 can intersect at the joint 810. For example, two, three, or four protrusions 140 can intersect at a joint.

The protrusions 140 can create a plurality of pockets 805. The pockets 805 can all have the same shape or different shapes. The pockets 805 can create a grid on the housing coupling surface 125 or the plate coupling surface 135. For example, the protrusions 140 can create a grid with a plurality of pockets 805 having the same shape. The grid can include a plurality of joints 810. Three protrusions can intersect at the joints 810 to form the hexagonal pockets 805. Four protrusions can intersect at the joints 810 to form square or rectangular pockets 805. The grid can be symmetrical or asymmetrical. For example, a protrusion density may be greater at a first location of the grid (e.g., at a center of the grid) than at a second location of the grid (e.g., a perimeter of the grid). The protrusions 140 can be dispersed randomly or create a pattern. A gap can be disposed between various protrusions 140 to provide a path for contaminants or particles to drain out of the battery pack assembly 100. A protrusion 140 can include an opening that extends through the protrusion 140 to provide the drain path for the contaminants or particles.

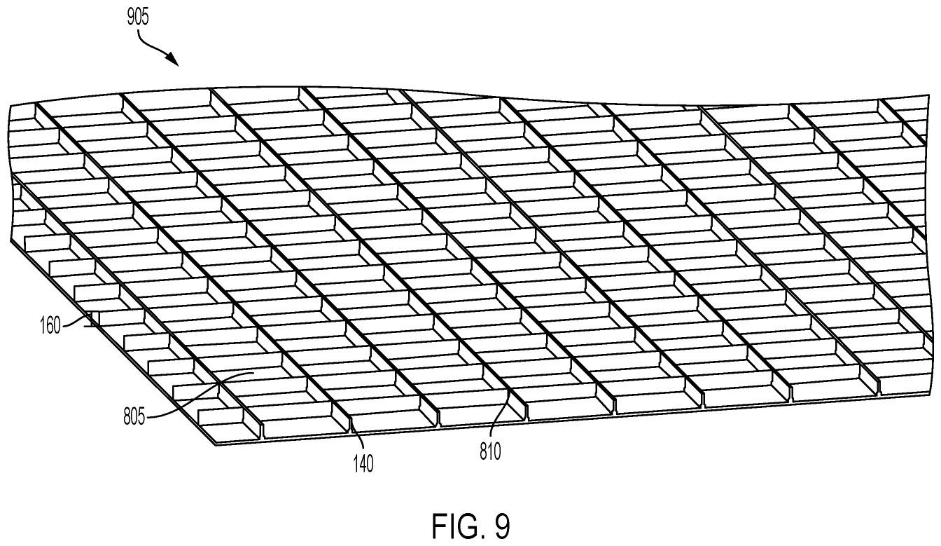

FIG. 9 depicts an example grid 905. The grid 905 can include any number of protrusions 140, any number of joints 810, and any number of pockets 805. The grid 905 can be integral with the housing 115 or the plate 130. The grid 905 can include pockets of any shape (e.g., hexagonal, rectangular, square, triangular, circular, asymmetrical, etc.). Prior to coupling the housing 115 with the plate 130 via the protrusions 140, the protrusions 140 can have an initial length 160. The initial length 160 can be the same across the grid 905 or can vary across the grid 905.

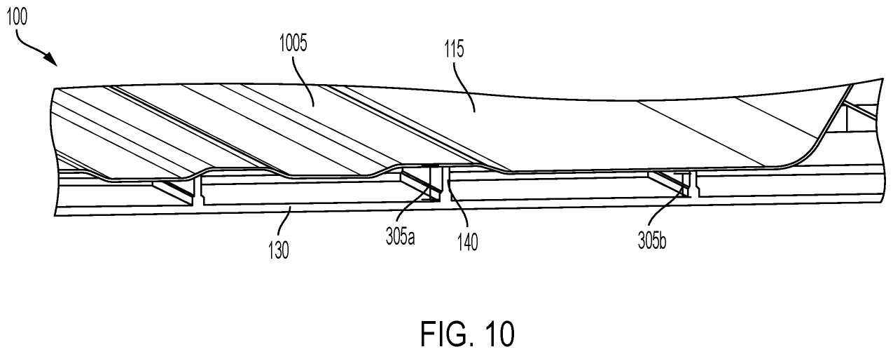

FIG. 10 depicts an example battery pack assembly 100. The battery pack assembly 100 can include a plurality of protrusions 140. The protrusions 140 can be integral with the plate 130. For example, the protrusions 140 and the plate 130 can be or form a monolithic structure. The housing 115 can have a non-planar shape. For example, the housing 115 can have at least one projections or indentation 1005. The plate 130 can have a shape that varies from (e.g., does not mirror) the housing 115. For example, the plate 130 can be planar. A distance between the plate 130 and the housing 115 can vary such that the coupling length 305 of the plurality of protrusions 140 can vary. For example, a first protrusion 140 can have a first coupling length 305a and a second protrusion 140 can have a second coupling length 305b.

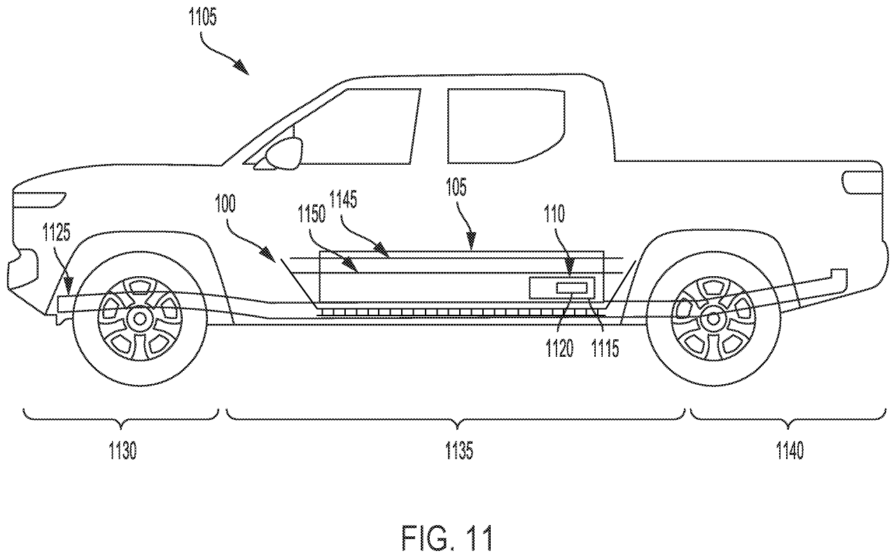

FIG. 11 depicts is an example cross-sectional view of an electric vehicle 1105 installed with at least one battery pack assembly 100. Electric vehicles 1105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. Yet, it should also be noted that battery pack 105 may also be used as an energy storage system to power a building, such as a residential home or commercial building. Electric vehicles 1105 can be fully electric or partially electric (e.g., plug-in hybrid) and further, electric vehicles 1105 can be fully autonomous, partially autonomous, or unmanned. Electric vehicles 1105 can also be human operated or non-autonomous. Electric vehicles 1105 such as electric trucks or automobiles can include on-board battery packs 105 to power the electric vehicles 1105. The battery packs 105 can be or include battery modules 1115 or battery cells 1120. The electric vehicle 1105 can include a chassis 1125 (e.g., a frame, internal frame, or support structure). The chassis 1125 can support various components of the electric vehicle 1105. The chassis 1125 can span a front portion 1130 (e.g., a hood or bonnet portion), a body portion 1135, and a rear portion 1140 (e.g., a trunk, payload, or boot portion) of the electric vehicle 1105. The battery pack assembly 100 can be installed or placed at least partially within the electric vehicle 1105. The plate 130 of the battery pack assembly can be disposed within the electric vehicle 1105 or be disposed external to the electric vehicle 1105. For example, the battery pack assembly 100 can be supported by the chassis 1125 of the electric vehicle 1105 within one or more of the front portion 1130, the body portion 1135, or the rear portion 1140. The battery pack 105 of the battery pack assembly 100 can include or connect with at least one busbar, e.g., a current collector element. For example, a first busbar 1145 and a second busbar 1150 can include electrically conductive material to connect or otherwise electrically couple the battery modules 1115 or the battery cells 1120 with other electrical components of the electric vehicle 1105 to provide electrical power to various systems or components of the electric vehicle 1105.

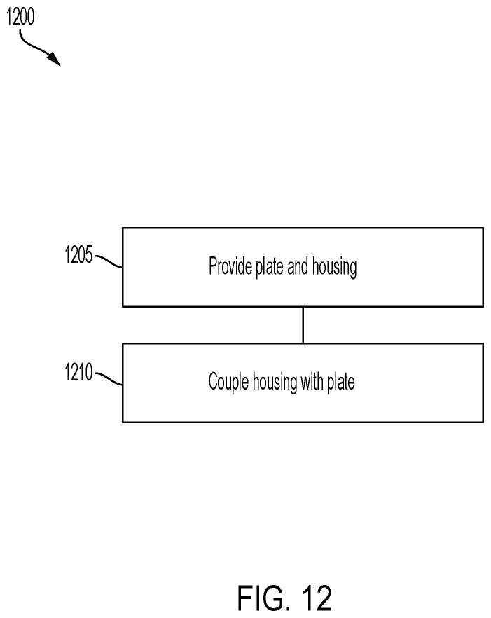

FIG. 12 depicts an example method 1200 of providing a battery pack assembly 100. Method 1200 can include providing a plate 130 and a housing (Act 1205). Act 1205 can include disposing the plate 130 away from the housing 115. The housing 115 can at least partially enclose the battery pack 105. The housing 115 can include at least one housing coupling surface 125. The plate 130 can include a plate coupling surface 135. The plate 130 can be disposed away from the housing 115.

Method 1200 can include coupling the housing 115 with the plate 130 (Act 1210). Act 1210 can include disposing at least one protrusion 140 between the housing 115 and the plate 130. At least a portion of the protrusion 140 (e.g., the tip 415) can melt to couple (e.g., weld) the housing 115 with the plate 130. The protrusion 140 can be integral with one of the housing 115 and the plate 130. For example, the protrusion 140 can be integral with the housing 115 and extend away from the housing coupling surface 125 toward the plate coupling surface 135. The protrusion 140 can be integral with the plate 130 and extend away from the plate coupling surface 135 toward the housing coupling surface 125. The protrusion 140 and the housing 115 or the plate 130 with which it is integral, can form a protrusion component 145. The other of the housing 115 or the plate 130 not integral with the protrusion 140 can be a heating component 150.

Act 1210 can include forming the protrusion 140. For example, the protrusion 140 can be formed to be integral with the housing 115 or the plate 130. Forming the protrusion at act 1210 can include forming a base 405 and a tip 415. The base 405 can include a first percentage of filler material and the tip 415 can include a second percentage of filler material. The first percentage can be greater than the second percentage.

Act 1210 can include coupling the housing 115 with the plate 130 via the protrusion 140. The protrusion 140 can be integral with the housing 115 or the plate 130. The protrusion 140 can have a first melting point. The other of the housing 115 or the plate 130 (e.g., the one that is not integral with the protrusion 140) can have a second melting point. The first melting point can be lower than the second melting point. Coupling the housing 115 with the plate 130 can include heating the other of the housing 115 or the plate 130 to a temperature between the first melting point and the second melting point. Act 1210 can include melting at least a portion of the protrusion 140. For example, at least a portion of the tip 415 of the protrusion 140 can melt. The housing 115 can be coupled with the plate 130 via the protrusion 140.

Act 1210 can include applying a bonding agent 155 to the housing 115 or the plate 130. The bonding agent 155 can, for example, be applied as a layer across a majority of the housing 115 or the plate 130, or can be applied to align with the protrusions 140. Act 1210 can include activating the bonding agent 155 by applying heat to the heating component 150. The activation of the bonding agent 155 can facilitate bonding or coupling between the protrusion 140 and the other of the housing 115 or the plate 130. The housing 115 can be coupled with the plate 130 by using no mechanical fasteners.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or clement is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of upper and lower components or top and bottom can be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
a plate spaced apart from a housing; and
the plate configured to couple with the housing via a protrusion, a portion of the protrusion to melt to couple the plate with the housing.

2. The apparatus of claim 1, comprising:
the portion of the protrusion comprising a first melting point, the protrusion integral with the plate; and
the housing comprising a second melting point, the first melting point lower than the second melting point, the housing to receive heat to melt the portion of the protrusion to couple the housing with the plate.

3. The apparatus of claim 1, comprising:
the portion of the protrusion comprising a first melting point, the protrusion integral with the housing; and
the plate comprising a second melting point, the first melting point lower than the second melting point, the plate to receive heat to melt the portion of the protrusion to couple the housing with the plate.

4. The apparatus of claim 1, comprising:
a bonding agent between the protrusion and the at least one of the housing or the plate, the bonding agent to interface with the protrusion to couple the plate with the housing.

5. The apparatus of claim 1, comprising:
the protrusion comprising:
a base comprising a first percentage of a filler material; and
a tip comprising a second percentage of the filler material, the first percentage greater than the second percentage.

6. The apparatus of claim 1, comprising:
the protrusion comprising:
an initial length prior to coupling the housing with the plate; and
a coupling length after coupling the housing with the plate, the coupling length less than the initial length, the portion of the protrusion to melt to reach the coupling length.

7. The apparatus of claim 1, comprising:
the protrusion comprising an initial length and a tip, the tip comprising:
a width; and
a tip length, the width less than twice the tip length.

8. The apparatus of claim 1, comprising:
a plurality of protrusions including the protrusion, the plurality of protrusions to define a pocket, the pocket comprising an area to receive an object with a minimum diameter of 30 mm.

9. The apparatus of claim 1, comprising:
a plurality of protrusions including the protrusion, the plurality of protrusions defining a plurality of pockets with a plurality of joints, the plurality of joints comprising three intersecting protrusions of the plurality of protrusions.

10. The apparatus of claim 1, comprising:
the plate to couple with the housing with no mechanical fasteners.

11. The apparatus of claim 1, comprising:
the housing being a housing of a battery pack, the battery pack to power an electric vehicle; and
the plate to be disposed external to the electric vehicle.

12. A method, comprising:
providing a plate and a housing; and
coupling the plate with the housing via a protrusion, a portion of the protrusion to melt to couple the housing with the plate.

13. The method of claim 12, wherein the protrusion is integral with the housing or the plate, the method comprising:
heating the other of the housing or the plate, the protrusion comprising a first melting point and the other of the housing or the plate comprising a second melting point, the first melting point lower than the second melting point;
melting the portion of the protrusion; and
coupling the housing with the plate via the protrusion.

14. The method of claim 12, comprising:
applying a bonding agent to the housing or the plate;
activating the bonding agent by applying heat; and
coupling the housing with the plate via the protrusion.

15. The method of claim 12, comprising:
forming the protrusion, the protrusion comprising:
a base comprising a first percentage of filler material; and
a tip comprising a second percentage of filler material, the first percentage of filler material greater than the second percentage of filler material.

16. An electric vehicle, comprising:
a battery pack comprising a housing;
a plate disposed away from the housing; and
a protrusion disposed at least partially between the housing and the plate, the plate to couple with the housing via the protrusion, the protrusion comprising a first melting point and at least one of the housing or the plate comprising a second melting point, the first melting point less than the second melting point.

17. The electric vehicle of claim 16, comprising:
the protrusion integral with the housing or the plate; and
the other of the housing or the plate comprising the second melting point, the other of the housing or the plate to receive heat to melt a portion of the protrusion to couple the housing with the plate.

18. The electric vehicle of claim 16, comprising:
a bonding agent to dispose between the protrusion and the at least one of the housing or the plate, the bonding agent to interface with the protrusion to couple the plate with the housing.

19. The electric vehicle of claim 16, comprising:
the protrusion comprising:
a base comprising a first percentage of a filler material; and
a tip comprising a second percentage of the filler material, the first percentage greater than the second percentage.

20. The electric vehicle of claim 16, comprising:
a plurality of protrusions including the protrusion, the plurality of protrusions defining a plurality of pockets having a hexagonal shape.
